(19) United States
(12) Patent Application Publication
(10) Pub. No.: US 2026/0155380 A1
(43) Pub. Date: Jun. 4, 2026

(54) SULFUR ELECTRODE FOR LITHIUM-SULFUR BATTERY INCLUDING CELLULOSE NANOFIBER BINDER AND LITHIUM-SULFUR BATTERY INCLUDING THE SAME

(71) Applicant: UIF (University Industry Foundation), Yonsei University, Seoul (KR)

(72) Inventors: Sang-Young LEE, Seoul (KR); Hyunseok MOON, Seoul (KR)

(73) Assignee: UIF (University Industry Foundation), Yonsei University, Seoul (KR)

(21) Appl. No.: 19/406,228

(22) Filed: Dec. 2, 2025

(30) Foreign Application Priority Data
Dec. 4, 2024 (KR) 10-2024-0178033

(51) Int. Cl. H01M 4/62; H01M 4/58; H01M 10/052; H01M 10/0567; H01M 10/0569

(52) U.S. Cl. CPC H01M 4/622; H01M 4/5815; H01M 10/052; H01M 10/0567; H01M 10/0569; H01M 2300/0037

(57) ABSTRACT

The present invention relates to a sulfur electrode composition for a lithium-sulfur battery, comprising: a cellulose nanofiber binder; and an active material comprising sulfur. Thereby, the sulfur electrode for a lithium-sulfur battery of the present invention maximizes the utilization rate and conversion reaction rate of sulfur in a lithium-sulfur battery even under minimal electrolyte conditions by introducing cellulose nanofibers as a binder, and the distance between the expanded glucose chains formed due to the one-dimensional structure and electrostatic repulsion of the cellulose nanofibers promotes the interaction between the binder and lithium polysulfide (LiPS), and effectively suppresses the formation of aggregates of lithium polysulfide (LiPS). Therefore, a lithium-sulfur battery including such a sulfur electrode maintains a high active material ratio even under minimal electrolyte conditions while increasing the electrochemical conversion reaction rate, thereby improving battery performance and significantly increasing energy density.

### CROSS-REFERENCE TO RELATED APPLICATIONS

This application claims priority to Korean Patent Application No. 10-2024-0178033, filed on Dec. 4, 2024, and all the benefits accruing therefrom under 35 U.S.C. § 119, the contents of which in its entirety are herein incorporated by reference.

### BACKGROUND

### 1. Field

The present invention relates to a sulfur electrode for a lithium-sulfur battery and a lithium-sulfur battery including the same, and more particularly, to a sulfur electrode for a lithium-sulfur battery introducing a binder for improving energy density and electrochemical performance, and a lithium-sulfur battery including the same.

### 2. Description of Related Art

The lithium-sulfur battery can theoretically provide high energy density (sulfur cathode 1,675 mAh/g and lithium metal anode 3,860 mAh/g), and is drawing attention as a next-generation battery due to its abundant resource advantages. However, the actual energy density of the lithium-sulfur battery is significantly lower than the theoretical value. This is because the weight ratio of the sulfur active material in the total weight of the battery is remarkably low compared to inactive components such as a separator, a current collector, an electrolyte, and packaging.

Particularly, since the electrolyte occupies the highest weight ratio in the battery, recently, a strategy of including a minimum amount of electrolyte in the battery has been adopted. However, under minimal electrolyte conditions, the viscosity of the electrolyte increases due to the dissolution of lithium polysulfide (LiPS) in the electrolyte, which causes a problem that the electrochemical conversion reaction rate of lithium ions (Li+) and lithium polysulfide (LiPS) slows down. Due to this problem, the reversible capacity of the lithium-sulfur battery is greatly reduced, and the energy density decreases.

In order to solve the above problems, research has been conducted to improve the conversion rate of lithium polysulfide (LiPS) by utilizing catalysts, carbon materials, and separators, but these methods still had limitations in that they reduced the weight ratio of the sulfur active material or increased the cost of manufacturing the battery. Accordingly, a new material strategy is required that can maximize the utilization of sulfur under minimal electrolyte conditions without requiring additional electrode components.

### REFERENCES

1. Chinese Patent Publication No. 115360353A
2. Electrochimica Acta Volume 235, 1 May 2017, Pages 399-408

### SUMMARY

The objective of the present invention is to solve the above problems and to provide a sulfur electrode for a lithium-sulfur battery utilizing a binder, which can improve the utilization rate and conversion reaction rate of sulfur even under conditions using an extremely small amount of electrolyte, and can simultaneously achieve high performance and high energy density of the battery, and a lithium-sulfur battery including the same.

According to one aspect of the present invention, a sulfur electrode composition for a lithium-sulfur battery including a cellulose nanofiber binder; and an active material including sulfur is provided.

The cellulose nanofiber may have an average diameter of 0.5-50 nm.

The average length of the cellulose nanofiber may be 50-2,000 nm.

The cellulose nanofiber may be 2,2,6,6-tetramethylpiperidine-1-oxyl (hereinafter referred to as ‘TEMPO’)-mediated cellulose nanofiber (or TEMPO-oxidized cellulose nanofiber, hereinafter referred to as ‘TOCN’).

The cellulose nanofiber binder may be included in an amount of 0.1-2 wt % based on the total weight of the sulfur electrode composition.

The sulfur electrode composition for a lithium-sulfur battery may include 5-15 parts by weight of the conductive material, based on 100 parts by weight of the active material.

The active material including sulfur may be one or more selected from inorganic sulfur (S₈), Li₂Sn (n≥1), disulfide compounds, organic sulfur compounds, carbon-sulfur complexes, and carbon-sulfur polymers ((C₂Sₓ)ₙ, x=2.5-50 integer, n≥2).

The conductive material may be one or more selected from particulate carbon-based conductive materials, linear carbon-based conductive materials, plate-like carbon-based conductive materials, metal fibers, metal powders, and conductive metal oxides.

The particulate carbon-based conductive material is any one selected from acetylene black, Ketjen black, channel black, furnace black, lamp black, thermal black, and carbon black, the linear carbon-based conductive material is any one selected from carbon nanotubes and conductive carbon fibers, and the plate-like carbon-based conductive material may be graphene.

According to another aspect of the present invention, an electrode for a lithium-sulfur battery including the sulfur electrode composition for a lithium-sulfur battery of any one of the preceding is provided.

In the present invention is provided a lithium-sulfur battery, which comprises the cathode for a lithium-sulfur battery; an anode including an anode active material; a separator positioned between the cathode and the anode; and an electrolyte injected into the separator.

The ratio of the electrolyte to the sulfur included in the cathode (E/S ratio, μL/mg) may be 0.5-15.

The electrolyte includes a solvent, an electrolyte salt, and an additive, and the solvent may be one or more selected from DOL (1,3-dioxolane), DME (1,2-dimethoxyethane), THF (tetrahydrofuran), TMS (tetramethylsulfone), EMS (ethylmethylsulfone), and MiPS (methylisopropylsulfone).

The electrolyte includes a solvent, an electrolyte salt, and an additive, and the electrolyte salt is LiCl, LiBr, LiI, LiClO₄, LiBF₄, LiB₁₀Cl₁₀, LiB(Ph)₄, LiC₄BO₈, LiPF₆, LiCF₃SO₃, LiCF₃CO₂, LiAsF₆, LiSbF₆, LiAlCl₄, LiSO₃CH₃, LiSCN, LiC(CF₃SO₂)₃, LiN(CF₃SO₂)₂, LiN(C₂F₅SO₂)₂, Li[N(SO₂CF₃)₂](LiTFSI), Li(SO₃CF₃)(LiTf) and Li[N(SO₂F)]₂ (LiFSI).

The electrolyte includes a solvent, an electrolyte salt, and an additive, and the additive may be LiNO₃.

According to yet another aspect of the present invention, a device selected from portable electronic devices, mobile units, power devices, and energy storage devices including the lithium-sulfur battery is provided.

According to yet another aspect of the present invention, a method for manufacturing a sulfur electrode for a lithium-sulfur battery is provided, including the steps of: (A) preparing a binder dispersion and a conductive material dispersion including cellulose nanofibers; (B) manufacturing an electrode composition by dispersing a sulfur cathode active material in the binder dispersion and the conductive material dispersion; and (C) casting the electrode composition onto a current collector and then drying.

The solvent used for preparing the binder dispersion and the conductive material dispersion may be one or more selected from water, N-methyl-2-pyrrolidone (NMP), dimethylformamide (DMF), tetrahydrofuran (THF), dimethyl sulfoxide (DMSO), and chloroform.

According to yet another aspect of the present invention, a method for manufacturing a lithium-sulfur battery including the method for manufacturing a sulfur electrode for a lithium-sulfur battery is provided.

The sulfur electrode for a lithium-sulfur battery of the present invention maximizes the utilization rate and conversion reaction rate of sulfur in a lithium-sulfur battery even under minimal electrolyte conditions by introducing cellulose nanofibers as a binder, and the distance between the expanded glucose chains formed due to the one-dimensional structure and electrostatic repulsion of the cellulose nanofibers promotes interaction between the binder and lithium polysulfide (LiPS), and effectively suppresses the formation of aggregates of lithium polysulfide (LiPS). Therefore, a lithium-sulfur battery including such a sulfur electrode maintains a high active material ratio even under minimal electrolyte conditions while increasing the electrochemical conversion reaction rate, thereby improving battery performance and significantly increasing energy density.

### BRIEF DESCRIPTION OF THE DRAWINGS

FIG. 1 is a schematic diagram of the electrode and electrolyte of the lithium-sulfur battery including the cellulose nanofiber binder of the present invention.

FIGS. 2A and 2B are SEM images of the electrode according to Experimental Example 1.

FIG. 3 is a result of specific surface area analysis of the electrode according to Example 1.

FIGS. 4A and 4B are results of resistance analysis of the lithium-sulfur battery according to the electrode binder and electrolyte E/S ratio of Experimental Example 2.

FIGS. 5A and 5B are results of reversible capacity analysis of the lithium-sulfur battery according to the electrode binder and electrolyte E/S ratio of Experimental Example 3.

FIGS. 6A and 6B are results of analyzing the lifetime characteristics of the lithium-sulfur battery according to the electrode binder and electrolyte E/S ratio of Experimental Example 4.

### DETAILED DESCRIPTION OF THE INVENTION

Hereinafter, examples of the present invention will be described in detail with reference to the accompanying drawings so that those skilled in the art to which the present invention pertains can easily carry out the present invention.

However, the following description is not intended to limit the present invention to specific embodiments, and the detailed description of the related known technology is omitted when it is determined that it may obscure the gist of the present invention in describing the present invention.

The terminology used herein is merely for the purpose of describing particular examples and is not intended to limit the present invention. Singular expressions include plural expressions unless the context clearly indicates otherwise. In the present application, terms such as “comprising” or “having” are intended to specify the presence of features, numbers, steps, operations, components, or combinations thereof described in the specification, but do not preclude in advance the presence or addition possibility of one or more other features, numbers, steps, operations, components, or combinations thereof.

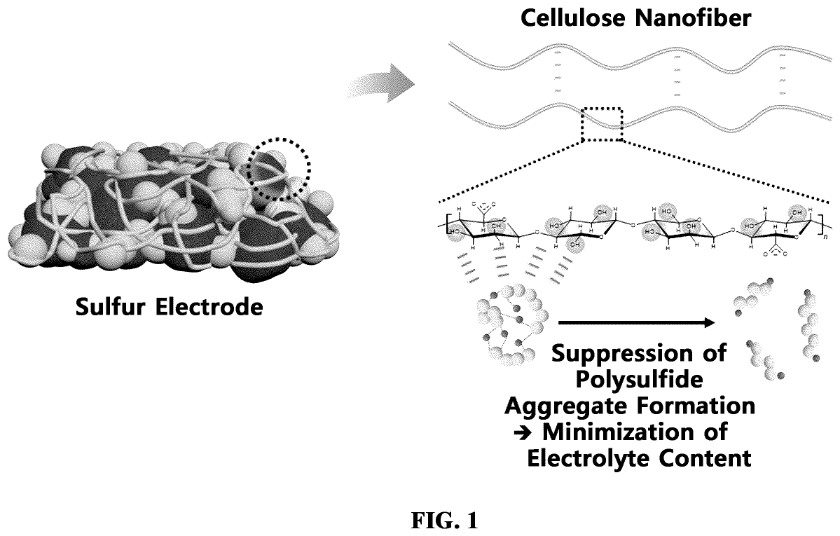

FIG. 1 is a schematic diagram of the electrode and electrolyte of the lithium-sulfur battery including the cellulose nanofiber binder of the present invention. Hereinafter, the sulfur electrode composition for a lithium-sulfur battery of the present invention will be described with reference to FIG. 1.

The sulfur electrode composition for a lithium-sulfur battery of the present invention includes a binder comprising cellulose nanofibers; and an active material including sulfur. If necessary, a conductive material may be further included.

According to one embodiment of the present invention, the cellulose nanofiber preferably has an average diameter of 0.5-50 nm, more preferably 0.7-20 nm, even more preferably 0.8-10 nm, and even more preferably 1-5 nm.

In addition, the average length of the cellulose nanofiber is preferably 50-2,000 nm, more preferably 100-1,500 nm, even more preferably 120-1000 nm, and most preferably 140-700 nm.

When the diameter and length of the cellulose nanofiber are within such ranges, the dispersibility and binding force as a sulfur electrode binder can be maximized. If the diameter and length of the cellulose nanofiber are less than the lower limit, the binding force may decrease, and if the diameter and length of the cellulose exceed the upper limit, the dispersibility may decrease.

In addition, such cellulose nanofibers have a one-dimensional structure and electrostatic repulsion, where the distance between the expanded glucose chains formed promotes the interaction between the cellulose nanofiber binder and lithium polysulfide (LiPS), and effectively suppresses the formation of aggregates of lithium polysulfide (LiPS). Accordingly, the electrochemical conversion reaction rate can be increased while maintaining a high active material ratio even under minimal electrolyte conditions, thereby significantly improving the performance of a lithium-sulfur battery applying such an electrode.

According to another embodiment of the present invention, the cellulose nanofiber is preferably a TEMPO-oxidized cellulose nanofiber (TOCN). This is because cellulose nanofibers obtained through the TEMPO-oxidized oxidation process include carboxyl functional groups carrying a negative charge, and this negative charge expands the distance between the nanofibers. Therefore, the specific surface area of the binder increases, and the interaction with lithium polysulfide (LiPS) can be enhanced.

According to yet another embodiment of the present invention, the cellulose nanofiber binder is preferably included in an amount of 0.1-2 wt % based on the total weight of the sulfur electrode composition, and more preferably, an extremely small amount of 0.5-1.5 wt %, and even more preferably 0.8-1.2 wt % may be applied.

As described above, the cellulose nanofiber binder is sufficient for electrode manufacturing even when an extremely small amount is used relative to the total weight of the electrode due to the very large specific surface area of the cellulose nanofiber, and it prevents the aggregation of active materials in the electrode, thereby enabling high reversible capacity even under conditions using a minimal amount of electrolyte.

The sulfur electrode composition for a lithium-sulfur battery preferably includes 5-15 parts by weight of the conductive material, based on 100 parts by weight of the active material, and more preferably 7-13 parts by weight. The composition ratio of the active material and the conductive material can be applied at the same level as that in a sulfur electrode of a conventional lithium-sulfur battery.

According to yet another embodiment of the present invention, the active material including sulfur may be inorganic sulfur (S₈), Li₂Sn (n≥1), disulfide compounds, organic sulfur compounds, carbon-sulfur complexes, and carbon-sulfur polymers ((C₂Sₓ)ₙ, where x=2.5-50 integer, and n≥2) or the like may be used. The cathode active material may be a conventional active material applied to a sulfur cathode of a lithium-sulfur battery.

According to yet another embodiment of the present invention, the conductive material may be particulate carbon-based conductive materials, linear carbon-based conductive materials, plate-like carbon-based conductive materials, metal fibers, metal powders, conductive metal oxides, or the like.

The particulate carbon-based conductive material is any one selected from acetylene black, Ketjen black, channel black, furnace black, lamp black, thermal black, and carbon black, the linear carbon-based conductive material is any one selected from carbon nanotubes and conductive carbon fibers, and the plate-like carbon-based conductive material may be graphene. The conductive material may be a conductive material conventionally applied to a sulfur cathode of a lithium-sulfur battery.

The present invention provides a lithium-sulfur electrode, preferably a cathode, including the sulfur electrode composition for a lithium-sulfur battery.

In the present invention is provided a lithium-sulfur battery, which comprises the cathode for a lithium-sulfur battery; an anode including an anode active material; the separator positioned between the cathode and the anode; and an electrolyte injected into the separator.

According to one embodiment of the present invention, the ratio of the electrolyte to sulfur in the cathode (E/S ratio, μL/mg) may be 0.5-15, particularly 1-10, preferably 1.5-9, more preferably 1.5-8, even more preferably 1.5-7.5, and most preferably 2-5. As such, the present invention can exhibit high reversible capacity even with a low electrolyte content.

In particular, in the present invention, when the binder is TEMPO-oxidized cellulose nanofiber (TOCN) and the E/S ratio is 1.5-7, the reversible capacity does not change even if the E/S ratio decreases, whereas if the binder is not TEMPO-oxidized cellulose nanofiber (TOCN) or has an E/S ratio outside the 1.5-7 range, the discharge capacity decreases as the E/S ratio decreases, showing a difference in effect. In this regard, in order to have a constant reversible capacity regardless of the E/S ratio, the binder is preferably TEMPO-oxidized cellulose nanofiber (TOCN) and has an E/S ratio of 1.5-7.

The anode active material may be one or more selected from lithium metal and lithium alloys.

The electrolyte includes a solvent, an electrolyte salt, and an additive.

The solvent may include ethers such as DOL (1,3-dioxolane), DME (1,2-dimethoxyethane), THF (tetrahydrofuran), and sulfones such as TMS (tetramethylsulfone), EMS (ethylmethylsulfone), MiPS (methylisopropylsulfone), and the like.

The electrolyte salt may include LiCl, LiBr, LiI, LiClO₄, LiBF₄, LiB₁₀Cl₁₀, LiB(Ph)₄, LiC₄BO₈, LiPF₆, LiCF₃SO₃, LiCF₃CO₂, LiAsF₆, LiSbF₆, LiAlCl₄, LiSO₃CH₃, LiSCN, LiC(CF₃SO₂)₃, LiN(CF₃SO₂)₂, LiN(C₂F₅SO₂)₂, Li[N(SO₂CF₃)₂] (LiTFSI), Li(SO₃CF₃) (LiTf), Li[N(SO₂F)]₂ (LiFSI), and the like.

The additive may be LiNO₃.

The solvent, electrolyte salt, and additive are not limited to the contents described above and may include components conventionally applied to the electrolyte of a lithium-sulfur battery.

The present invention provides a device selected from portable electronic devices, mobile units, power devices, and energy storage devices including the lithium-sulfur battery.

The present invention provides a method for manufacturing a sulfur electrode for a lithium-sulfur battery.

The method for manufacturing a sulfur electrode for a lithium-sulfur battery of the present invention may include the steps of: preparing a binder dispersion and a conductive material dispersion including cellulose nanofibers; manufacturing an electrode composition by dispersing a sulfur cathode active material in the binder dispersion and the conductive material dispersion; and casting the electrode composition onto a current collector and then drying.

The solvent used for manufacturing the binder dispersion and the conductive material dispersion may be water, N-methyl-2-pyrrolidone (NMP), dimethylformamide (DMF), tetrahydrofuran (THF), dimethyl sulfoxide (DMSO), chloroform, or the like, and preferably environmentally safe water can be used by excluding the use of organic solvents.

The method of drying the solvent contained in the dispersion can be performed by various methods such as freeze-drying, spray-drying, or hot-air drying.

The present invention provides a method for manufacturing a lithium-sulfur battery including the method for manufacturing a sulfur electrode for a lithium-sulfur battery.

Hereinafter, the present invention will be described in detail with reference to examples according to the present invention.

### EXAMPLES

### Preparation Example 1: Manufacturing of TEMPO-Oxidized Cellulose Nanofiber (TOCN)

TEMPO-oxidized cellulose nanofibers were prepared according to the method described in Electrochimica Acta 369 (2021) 137708. Undried cellulose pulp was washed with HCl solution (pH 2), and 20 g of dried pulp was put into sodium phosphate buffer (1800 mL, pH 6.8) at 60° C. 2,2,6,6-tetramethylpiperidine-1-oxyl (TEMPO) radical (0.1 mmol, Alfa Aesar, 98%) was added to the solution, then sodium chlorite (0.2 mol, Sigma Aldrich, 80%) was added and dissolved, and then sodium hypochlorite (1 mol, 10-15%) was added. The suspension was stirred for 140 minutes, vacuum filtered, and washed with deionized water. 1% TEMPO-oxidized cellulose nanofibers were prepared and homogenized at high pressure (1,600 bar) using a microfluidics processor. The resulting TEMPO-oxidized cellulose nanofibers had an average diameter of 1.55±0.53 nm and an average length of 0.39±0.25 μm.

### Example 1: Manufacturing of Sulfur Cathode Based on Nanocellulose Binder

As sulfur cathode materials, a sulfur-carbon complex (sulfur@MWCNT, sulfur:carbon weight ratio=8:2), a mixture of Super P and single-walled carbon nanotubes (SWCNT) (Super P:SWCNT weight ratio=8.5:0.5), and TEMPO-oxidized cellulose nanofiber (TOCN) prepared according to Preparation Example 1 were prepared as an active material, a conductive material, and a binder, respectively.

To manufacture the sulfur cathode, a 1 wt % TOCN binder aqueous dispersion and a conductive material aqueous dispersion were prepared separately, and then the active material was added to the mixed aqueous dispersion and dispersed. At this time, the electrode composition was manufactured with a weight ratio of active material:conductive material:binder of 90:9:1. The manufactured electrode composition was cast onto an aluminum (Al) current collector at 100 μm, dried at 50° C. for 6 hours, and then vacuum dried at 50° C. for an additional 12 hours to remove moisture in the electrode.

### Comparative Example 1: Manufacturing of Sulfur Electrode Based on Carboxymethyl Cellulose (CMC)

A sulfur electrode was manufactured under the same conditions as Example 1, except that carboxymethyl cellulose (CMC) was used instead of TEMPO-oxidized cellulose nanofiber (TOCN) as the binder.

### Device Example 1: Manufacturing of Lithium-Sulfur Battery Including Sulfur Electrode Based on TEMPO-Oxidized Nanocellulose (TOCN) (E/S Ratio=2)

A Celgard 2400 separator was laminated on the sulfur electrode manufactured according to Example 1, an electrolyte was applied so that the electrolyte/sulfur ratio (E/S ratio, μL/mg) became 2, and then a 50 μm Li foil was laminated.

The electrolyte used was one mixed with 0.1 M LiTFSI (lithium bis(trifluoromethanesulfonyl)imide) in DOL (1,3-dioxolane)/DME (1,2-dimethoxyethane) (1/1, v/v) including 2 wt % lithium nitrate as an additive.

After the electrolyte was injected, the battery underwent a stabilization process for 4 hours, and after the stabilization process, it was discharged with a current of 0.1 C to activate the battery. Charge/discharge performance tests were evaluated in the voltage range of 1.7-2.7 V with charge/discharge currents of 0.1C/0.2C.

### Device Example 2: Manufacturing of Lithium-Sulfur Battery Including Sulfur Cathode Based on TEMPO-Oxidized Nanocellulose (TOCN) (E/S Ratio=2.5)

A lithium-sulfur battery was manufactured under the same conditions as Device Example 1, except that the electrolyte was applied so that the electrolyte/sulfur ratio (E/S ratio) became 2.5.

### Device Example 3: Manufacturing of Lithium-Sulfur Battery Including Sulfur Cathode Based on TEMPO-Oxidized Nanocellulose (TOCN) (E/S Ratio=3)

A lithium-sulfur battery was manufactured under the same conditions as Device Example 1, except that the electrolyte was applied so that the electrolyte/sulfur ratio (E/S ratio) became 3.

### Device Example 4: Manufacturing of Lithium-Sulfur Battery Including Sulfur Cathode Based on TEMPO-Oxidized Nanocellulose (TOCN) (E/S Ratio=5)

A lithium-sulfur battery was manufactured under the same conditions as Device Example 1, except that the electrolyte was applied so that the electrolyte/sulfur ratio (E/S ratio) became 5.

### Device Example 5: Manufacturing of Lithium-Sulfur Battery Including Sulfur Cathode Based on TEMPO-Oxidized Nanocellulose (TOCN) (E/S Ratio=8)

A lithium-sulfur battery was manufactured under the same conditions as Device Example 1, except that the electrolyte was applied so that the electrolyte/sulfur ratio (E/S ratio) became 8.

### Device Comparative Example 1: Manufacturing of Lithium-Sulfur Battery Including Sulfur Electrode Based on Carboxymethyl Cellulose (CMC) (E/S Ratio=2)

A lithium-sulfur battery was manufactured under the same conditions as Device Example 1, except that it included a sulfur electrode manufactured using a carboxymethyl cellulose (CMC) binder instead of a sulfur electrode manufactured using a TEMPO-oxidized cellulose nanofiber (TOCN) binder.

### Device Comparative Example 2: Manufacturing of Lithium-Sulfur Battery Including Sulfur Electrode Based on Carboxymethyl Cellulose (CMC) (E/S Ratio=2.5)

A lithium-sulfur battery was manufactured under the same conditions as Device Example 2, except that it included a sulfur electrode manufactured using a carboxymethyl cellulose (CMC) binder instead of a sulfur electrode manufactured using a TEMPO-oxidized cellulose nanofiber (TOCN) binder.

### Device Comparative Example 3: Manufacturing of Lithium-Sulfur Battery Including Sulfur Electrode Based on Carboxymethyl Cellulose (CMC) (E/S Ratio=3)

A lithium-sulfur battery was manufactured under the same conditions as Device Example 3, except that it included a sulfur electrode manufactured using a carboxymethyl cellulose (CMC) binder instead of a sulfur electrode manufactured using a TEMPO-oxidized cellulose nanofiber (TOCN) binder.

### Device Comparative Example 4: Manufacturing of Lithium-Sulfur Battery Including Sulfur Electrode Based on Carboxymethyl Cellulose (CMC) (E/S Ratio=5)

A lithium-sulfur battery was manufactured under the same conditions as Device Example 4, except that it included a sulfur electrode manufactured using a carboxymethyl cellulose (CMC) binder instead of a sulfur electrode manufactured using a TEMPO-oxidized cellulose nanofiber (TOCN) binder.

### Device Comparative Example 5: Manufacturing of Lithium-Sulfur Battery Including Sulfur Electrode Based on Carboxymethyl Cellulose (CMC) (E/S Ratio=8)

A lithium-sulfur battery was manufactured under the same conditions as Device Example 5, except that it included a sulfur electrode manufactured using a carboxymethyl cellulose (CMC) binder instead of a sulfur electrode manufactured using a TEMPO-oxidized cellulose nanofiber (TOCN) binder.

Table 1 below summarizes the sulfur electrode binders and E/S ratios of Device Examples 1-5 and Device Comparative Examples 1-5.

TABLE 1

| Classification | Sulfur Electrode Binder | E/S ratios |
|---|---|---|
| Device Ex. 1 | TEMPO-oxidized | 2 |
| | Nanocellulose (TOCN) | |
| Device Ex. 2 | TEMPO-oxidized | 2.5 |
| | Nanocellulose (TOCN) | |
| Device Ex. 3 | TEMPO-oxidized | 3 |
| | Nanocellulose (TOCN) | |
| Device Ex. 4 | TEMPO-oxidized | 5 |
| | Nanocellulose (TOCN) | |
| Device Ex. 5 | TEMPO-oxidized | 8 |
| | Nanocellulose (TOCN) | |
| Device Comp. | Carboxymethyl | 2 |
| Ex. 1 | Cellulose (CMC) | |
| Device Comp. | Carboxymethyl | 2.5 |
| Ex. 2 | Cellulose (CMC) | |
| Device Comp. | Carboxymethyl | 3 |
| Ex. 3 | Cellulose (CMC) | |
| Device Comp. | Carboxymethyl | 5 |
| Ex. 4 | Cellulose (CMC) | |
| Device Comp. | Carboxymethyl | 8 |
| Ex. 5 | Cellulose (CMC) | |

### Experimental Example 1: Sulfur Electrode SEM Image and Electrode Specific Surface Area Analysis

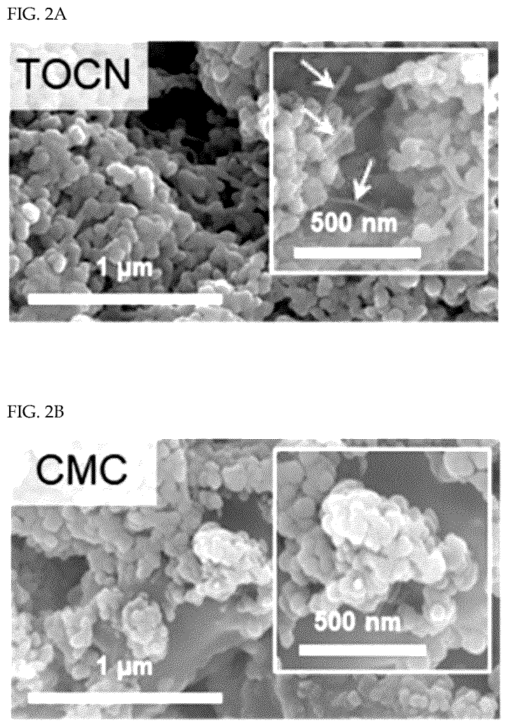

FIGS. 2A to 2B compare the SEM images of the sulfur electrode based on the TEMPO-oxidized nanocellulose (TOCN) binder of Example 1 (a) and the sulfur electrode based on carboxymethyl cellulose (CMC) of Comparative Example 1 (b).

According to this, it is confirmed that the sulfur electrode of Example 1 forms smaller pores and more pores than the sulfur electrode of Comparative Example 1, and it can be confirmed that nanoscale cellulose binders having a diameter in the range of 1-50 nm are distributed as indicated by the arrows.

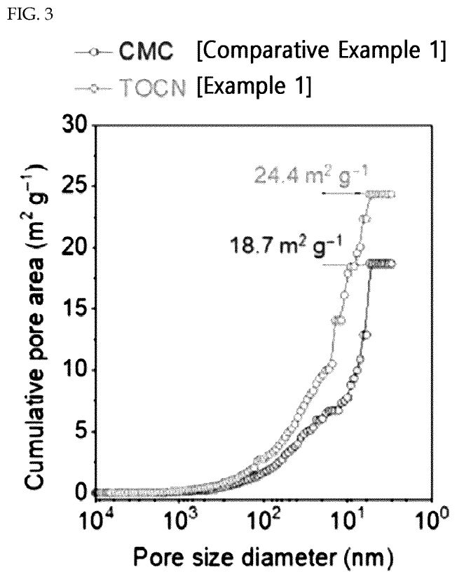

FIG. 3 is a result of analyzing the pore size distribution and specific surface area of the sulfur electrode based on the TEMPO-oxidized nanocellulose (TOCN) binder of Example 1 (a) and the sulfur electrode based on carboxymethyl cellulose (CMC) of Comparative Example 1 (b).

According to this, it was found that the sulfur electrode based on the TEMPO-oxidized nanocellulose (TOCN) binder of Example 1 had a relatively higher specific surface area compared to the conventional sulfur electrode based on carboxymethyl cellulose (CMC) of Comparative Example 1.

### Experimental Example 2: Resistance Analysis of Lithium-Sulfur Battery

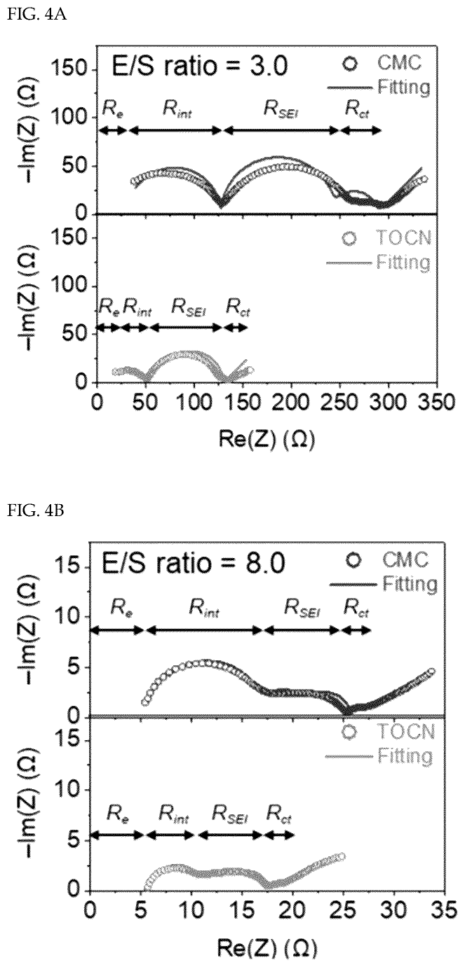

In order to analyze the effect of the electrode form on the battery performance, for the lithium-sulfur batteries of Device Example 3 and Device Comparative Example 3 having the same E/S ratio of 3, and the lithium-sulfur batteries of Device Example 5 and Device Comparative Example 5 having the same E/S ratio of 8, EIS (Electrochemical Impedance Spectroscopy) analysis was performed after discharging up to 2.1 V, and the results are shown in FIGS. 4A to 4B. Here, (a) shows the result of the resistance analysis of Device Example 3 (TOCN) and Device Comparative Example 3 (CMC) having an E/S ratio of 3, and (b) shows the result of the resistance analysis of Device Example 5 (TOCN) and Device Comparative Example 5 (CMC) having an E/S ratio of 8.

According to this, regardless of the E/S ratio, the resistance of the lithium-sulfur batteries of Device Examples 3 and 5, including the TEMPO-oxidized nanocellulose (TOCN) binder-based electrode, was found to be lower than that of the lithium-sulfur batteries of Device Comparative Examples 3 and 5, including the carboxymethyl cellulose (CMC) binder-based electrode. This result indicates that the TEMPO-oxidized nanocellulose (TOCN) binder-based electrode having a large specific surface area reduces the resistance of the battery.

### Experimental Example 3: Capacity Analysis of Lithium-Sulfur Battery

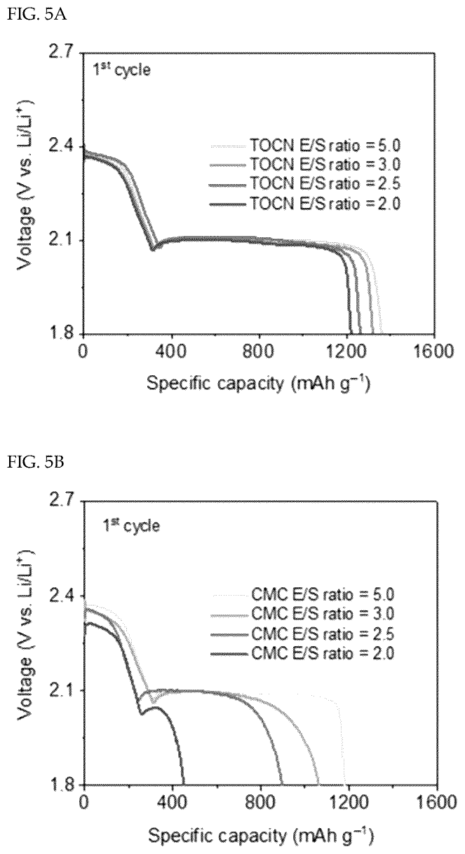

In order to analyze the tendency of change in reversible capacity according to the electrode binder and the E/S ratio, the reversible capacity of the battery was analyzed for (a) Device Examples 1˜4 (E/S ratios 2, 2.5, 3, 5, respectively), and (b) Device Comparative Examples 1˜4 (E/S ratios 2, 2.5, 3, 5, respectively), and the results are shown in FIGS. 5A to 5B.

According to this, in the lithium-sulfur batteries of Device Comparative Examples 1˜4 including the carboxymethyl cellulose (CMC) binder-based sulfur electrode, the discharge capacity severely decreases as the electrolyte content (E/S ratio) decreases, whereas in the lithium-sulfur batteries of Device Examples 1˜4 including the TEMPO-oxidized nanocellulose (TOCN) binder-based sulfur electrode, the reversible capacity was found to hardly decrease even if the E/S ratio decreases.

This result means that the unique structure of the nanocellulose binder accelerates the conversion reaction of sulfur by reducing the resistance caused by the increase in the viscosity of lithium polysulfide (LiPS) in the battery, and among them, a high discharge capacity of 1,221 mAh/g was observed in the lithium-sulfur battery of Device Example 1, particularly under the practical cell operating condition where the E/S ratio is 2.

### Experimental Example 4: Lifetime Characteristics Analysis of Lithium-Sulfur Battery

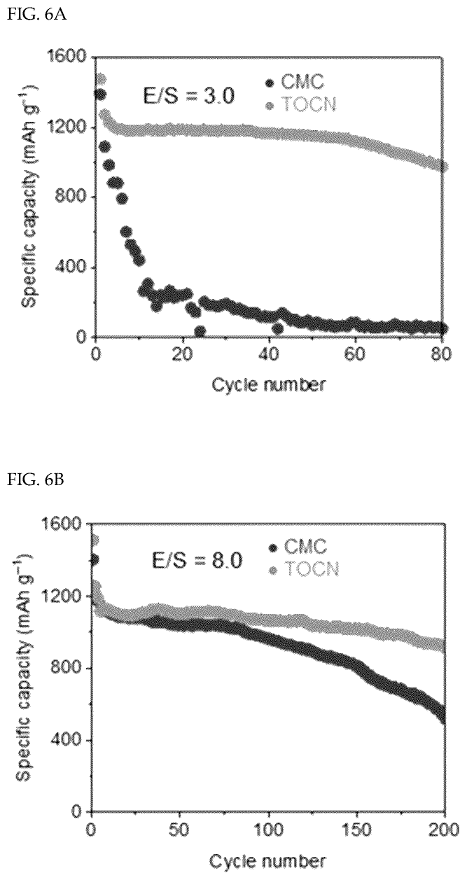

In order to observe the lifetime characteristics of the lithium-sulfur battery according to the electrode binder and the E/S ratio, cycle characteristics were analyzed for the lithium-sulfur batteries of Device Example 3 and Device Comparative Example 3 having the same E/S ratio of 3, and the lithium-sulfur batteries of Device Example 5 and Device Comparative Example 5 having the same E/S ratio of 8, and the results are shown in FIGS. 6A to 6B.

According to this, compared to Device Comparative Examples 3 and 5 including the carboxymethyl cellulose (CMC) binder-based sulfur electrode, the lithium-sulfur batteries of Device Examples 3 and 5 including the TEMPO-oxidized nanocellulose (TOCN) binder-based sulfur electrode exhibited significantly higher lifetime characteristics.

In particular, under the practical cell operating condition where the E/S ratio is 3, in Device Comparative Example 3, the capacity expression rapidly decreases as the number of cycles increases, whereas in Device Example 3, it can be confirmed that the capacity expression hardly changes even if the number of cycles increases.

In the present invention, it can be seen that even with a very small content of 1 wt % of the electrode binder, the electrolyte content in the battery can be reduced to the level of practical cell operating conditions, and moreover, the lifetime characteristics of the battery can be improved.

Although examples of the present invention have been described above, those skilled in the art to which the present invention pertains will be able to variously modify and change the present invention by addition, alteration, deletion or addition of components, etc., without departing from the spirit of the present invention described in the claims, and these modifications and changes are also included in the scope of the present invention.

What is claimed is:

1. A sulfur electrode composition for a lithium-sulfur battery, comprising: a cellulose nanofiber binder; and an active material comprising sulfur.

2. The sulfur electrode composition for a lithium-sulfur battery of claim 1, wherein the cellulose nanofiber has an average diameter of 0.5-50 nm.

3. The sulfur electrode composition for a lithium-sulfur battery of claim 2, wherein the average length of the cellulose nanofiber is 50-2,000 nm.

4. The sulfur electrode composition for a lithium-sulfur battery of claim 1, wherein the cellulose nanofiber is TEMPO-oxidized cellulose nanofiber (TOCN).

5. The sulfur electrode composition for a lithium-sulfur battery of claim 1, wherein the cellulose nanofiber binder is included in an amount of 0.1-2 wt % based on the total weight of the sulfur electrode composition.

6. The sulfur electrode composition for a lithium-sulfur battery of claim 1, wherein the sulfur electrode composition for a lithium-sulfur battery includes 5-15 parts by weight of the conductive material, based on 100 parts by weight of the active material.

7. The sulfur electrode composition for a lithium-sulfur battery of claim 1, wherein the active material comprising sulfur is one or more selected from inorganic sulfur (S₈), Li₂Sn (n≥1), disulfide compounds, organic sulfur compounds, carbon-sulfur complexes, and carbon-sulfur polymers ((C₂Sₓ)ₙ, where x=2.5-50 integer, and n≥2).

8. The sulfur electrode composition for a lithium-sulfur battery of claim 1, wherein the conductive material is one or more selected from particulate carbon-based conductive materials, linear carbon-based conductive materials, plate-like carbon-based conductive materials, metal fibers, metal powders, and conductive metal oxides.

9. The sulfur electrode composition for a lithium-sulfur battery of claim 8, wherein the particulate carbon-based conductive material is any one selected from acetylene black, Ketjen black, channel black, furnace black, lamp black, thermal black, and carbon black, the linear carbon-based conductive material is any one selected from carbon nanotubes and conductive carbon fibers, and the plate-like carbon-based conductive material is graphene.

10. A sulfur electrode for a lithium-sulfur battery, which comprises the sulfur electrode composition for a lithium-sulfur battery according to claim 1.

11. A lithium-sulfur battery comprising:
the cathode for a lithium-sulfur battery of claim 10;
an anode comprising an anode active material;
a separator positioned between the cathode and the anode; and
an electrolyte injected into the separator.

12. The lithium-sulfur battery of claim 11, wherein the ratio of the electrolyte to the sulfur included in the cathode (E/S ratio (μL/mg)) is 0.5-15.

13. The lithium-sulfur battery of claim 11,
wherein the electrolyte comprises a solvent, an electrolyte salt, and an additive, and the solvent is one or more selected from DOL (1,3-dioxolane), DME (1,2-dimethoxyethane), THF (tetrahydrofuran), TMS (tetramethylsulfone), EMS (ethylmethylsulfone), and MiPS (methylisopropylsulfone).

14. The lithium-sulfur battery of claim 11, wherein the electrolyte comprises a solvent, an electrolyte salt, and an additive, and the electrolyte salt is one or more selected from LiCl, LiBr, LiI, LiClO₄, LiBF₄, LiB₁₀Cl₁₀, LiB(Ph)₄, LiC₄BO₈, LiPF₆, LiCF₃SO₃, LiCF₃CO₂, LiAsF₆, LiSbF₆, LiAlCl₄, LiSO₃CH₃, LiSCN, LiC(CF₃SO₂) 3, LiN(CF₃SO₂)₂, LiN(C₂F₅SO₂)₂, Li[N(SO₂CF₃)₂](LiTFSI), Li(SO₃CF₃)(LiTf) and Li[N(SO₂F)]₂ (LiFSI).

15. The lithium-sulfur battery of claim 11, wherein the electrolyte comprises a solvent, an electrolyte salt, and an additive, and the additive is LiNO₃.

16. A device selected from portable electronic devices, mobile units, power devices, and energy storage devices, comprising the lithium-sulfur battery of claim 11.

17. A method for manufacturing a sulfur electrode for a lithium-sulfur battery, comprising the steps of: preparing a binder dispersion and a conductive material dispersion comprising cellulose nanofibers;
manufacturing an electrode composition by dispersing a sulfur cathode active material in the binder dispersion and the conductive material dispersion; and
casting the electrode composition onto a current collector and then drying.

18. The method for manufacturing a sulfur electrode for a lithium-sulfur battery of claim 17, wherein the solvent used for preparing the binder dispersion and the conductive material dispersion is one or more selected from water, N-methyl-2-pyrrolidone (NMP), dimethylformamide (DMF), tetrahydrofuran (THF), dimethyl sulfoxide (DMSO), and chloroform.

19. A method for manufacturing a lithium-sulfur battery, comprising the method for manufacturing a sulfur electrode for a lithium-sulfur battery of claim 17.
